(19) United States
(12) Patent Application Publication
(10) Pub. No.: US 2006/0002455 A1
(43) Pub. Date: Jan. 5, 2006

(54) Millimeter wave communications system with grid amplifier

(75) Inventors: Paul Johnson, Kihei, HI (US); John Lovberg, San Diego, CA (US)

Correspondence Address: TREX ENTERPRISES CORP., 10455 PACIFIC COURT, SAN DIEGO, CA, 92121, US

(73) Assignee: TREX ENTERPRISES CORP.

(21) Appl. No.: 11/212,322

(22) Filed: Aug. 25, 2005

Related U.S. Application Data
(63) Continuation-in-part of application No. 10/859,006, filed on Jun. 2, 2004.
(60) Provisional application No. 60/638,661, filed on Dec. 23, 2004.

(51) Int. Cl. H04B 1/38

(52) U.S. Cl. 375/219

(57) ABSTRACT

A high data rate free space communication link operating at millimeter wave frequency ranges. A quasi-optical grid amplifier is used provide increased transmitter output power. In preferred embodiments that output power is greater than 1 watt. Links include two transceivers, the first transceiver transmitting at a first frequency range and receiving at a second frequency range and a second transceiver transmitting at the second frequency range and receiving at the first frequency range. Each of the two transceivers has a primary tunable oscillator providing a basic frequency signal that is precisely the same for both transceivers. Preferably the primary tunable oscillator in one of the transceivers, the slave oscillator, is slaved to the primary tunable oscillator, the master oscillator, in the other transceiver and the two transceivers are locked in frequency and phase.

### FIELD OF THE INVENTION

The present invention is a continuation-in-part of Ser. No. 10/859,006 filed Jun. 2, 2004 and claims the benefit of Provisional Application 60/638,661, filed Dec. 23, 2004. The present invention pertains generally to communications systems and more particularly, to point-to-point and ground-to-air communications systems operating with high data rates at millimeter-wave frequencies.

### BACKGROUND OF THE INVENTION

### Wireless Links

Wireless communications links are well known in the prior art. An important advantage of wireless systems is that they do not require the laying or stringing of cables between stations. Two types of wireless systems that are finding many new applications are free space optical systems, which carry communications signals on light beams, microwave systems, which carry communications signals on microwave beams in the 3 GHz to 30 GHz spectral range (wavelengths of 10 cm to 1 cm), and millimeter-wave systems, which carry communications signals on millimeter wave beams in the 30 GHz to 300 GHz spectral range.

### Laser Links

Laser data links are capable of handling high data transmission rates, which are in the range of several Gigabits per second (Gbps). Certain types of atmospheric conditions, however, can adversely affect laser data links. For instance, it can be shown that haze, fog, or heavy snow conditions will cause severe attenuation of the laser beam. This attenuation is due to scattering and attenuation, and when it happens, the laser data link becomes unreliable.

### Microwave Links

Microwave links have certain shortcomings different from those associated with laser links. Specifically, microwave data links generally have a lower data transmission rate than laser systems. Typically, rather than transmitting data at rates of Gbps, the data transmission rate for a microwave data link is less than a few hundred Megabits per second (Mbps). Further, microwave links tend to have large beam divergences, which can cause interference if multiple links are operating in the same geographical region. Thus, microwave frequencies used for communications are either allocated via expensive licenses or, where unlicensed, may be subject to interference from other users.

### Millimeter Wave Links

Millimeter-wave wave links have advantages that overcome some of the shortcomings of both laser links and microwave links. Millimeter-wave links have both longer ranges for terrestrial applications than laser data links and higher data rate capabilities than microwave links.

### FCC Allocated Spectrum

Recently, the Federal Communications Commission (FCC) in the United States has established rules that allow for commercial communication systems in a new part of the electromagnetic spectrum, i.e., from 71-76 GHz and 81-86 GHz. This allocated spectrum is part of the millimeter wave spectrum (30 GHz to 300 GHz frequency, 10 mm to 1 mm) and more specifically part of a spectral range designated as the “E-Band” (60-90 GHz). Use of these spectral ranges for communications provides some of the advantages associated with free space optics (laser communications) systems and microwave communications systems, while eliminating some of the disadvantages. Specifically, the available spectral ranges are large enough to accommodate high simultaneous send and receive data rates of 2.5 Gbps and even 10 Gbps like laser communications systems, but the transmission suffers much lower attenuation in haze, fog, or snow as compared to laser communication links. Furthermore, with antennas having diameters on the order of two feet, the beams become so narrow that interference between different links is not normally an issue. This has allowed the FCC to provide for a simplified and inexpensive site licensing procedure for communications systems in this band.

### Grid Amplifiers

FIG. 10 shows the grid amplifier disclosed in Kim et al., “A Grid Amplifier”, IEEE Microwave and Guided Nave Letters, Vol. 1, No. 11, November 1991, the disclosure of which is incorporated herein by reference. Input microwaves with a vertically polarized E field pass, left to right, through an input polarizer of horizontal wires and incident on a grid amplifier. The horizontal wires block any horizontally polarized component of the input microwaves. The grid amplifier amplifies the vertically polarized input microwaves and radiates horizontally polarized output microwaves, both to the left and to the right.

The output microwaves moving to the right pass through an output polarizer of vertical wires, which have no effect on the horizontally polarized output microwaves. The (horizontally polarized) output microwaves moving to the left reflect from the horizontal wires of the input polarizer and pass through the amplifier grid unchanged; the amplifier grid detects only vertically polarized microwaves. The input polarizer is placed at a distance from the amplifier grid such that the reflected microwaves from the input polarizer combine constructively with the output microwaves propagated from the amplifier grid directly to the right. The input polarizer also prevents (or greatly reduces) feedback of the output microwaves back into the input horn. These polarizers provide the additional functions of independent tuning of the input and output circuits; that is, the act as matching impedances for the grid amplifiers.

Grid amplifier arrays were developed primarily for amplifying high-frequency microwaves transmitted in waveguides in communications and similar applications and this is the typical use of such amplifiers today. Descriptions of some of these systems are described in the following patents all of which are incorporated by reference: 5,214,394, 5,481,223, 6,538,793, 6,559,724 and 6,583,672. To the best of Applicant's knowledge these grid amplifiers have not been utilized for amplifying transmit signals of millimeter radios. Grid amplifiers are available from suppliers such as Wavestream Corporation with offices in San Dimas, Calif.

In light of the above, an object of the present invention is to increase the range capability of a millimeter-wave link. Another object of the present invention is to provide a wireless millimeter wave communications system that is available for effective data transfer between line-of-sight stations at high availability in a variety of atmospheric conditions. Another object of the present invention is to provide wireless millimeter wave communications links that are compact and space efficient, with a single antenna at each end of each link combining both transmit and receive functions. A further object of the present invention is to provide a wireless millimeter wave communications system that is relatively simple to manufacture, easy to install and use and comparatively cost effective.

### SUMMARY OF THE INVENTION

The present invention provides a high data rate free space communication link operating at millimeter wave frequency ranges. A quasi-optical grid amplifier is used to provide increased transmitter output power. In preferred embodiments the output power is greater than 1 watt. Links include two transceivers, the first transceiver transmitting at a first frequency range and receiving at a second frequency range and a second transceiver transmitting at the second frequency range and receiving at the first frequency range. Each of the two transceivers has a primary tunable oscillator providing a basic frequency signal that is precisely the same for both transceivers. Preferably the primary tunable oscillator in one of the transceivers, the slave oscillator, is slaved to the primary tunable oscillator, the master oscillator, in the other transceiver and the two transceivers are locked in frequency and phase. Also preferably the master oscillator is frequency controlled to maintain a constant number of wavelengths in the millimeter wave radio beams between the two transceivers, at least for periods of time permitting substantial data transmission without change in the number of wavelengths. In both transceivers a center frequency is generated by frequency multiplication and mixing of harmonics of the basic frequency signal generated by the transceiver's primary tunable oscillator. Preferred embodiments are designed to operate at frequencies above 60 GHz. In a particular preferred embodiment the center frequency for the first transceiver is about 73.5 GHz and the center frequency for the second transceiver is about 83.3 GHz. Embodiments of the present invention include automatic transmit power control, (preferably about 20 db of it, permitting operation at about 1 percent to 100 percent of maximum transmit power) for assuring adequate signal transmission in a wide variety of atmospheric conditions but not excessive power that might interfere with other links at the same frequencies. The narrow beam widths of these transceivers at about 0.5 degrees using a two-foot diameter antenna and the above transmit power control permit a large number of these transceivers to operate in the same region using the same frequencies.

In this preferred embodiment the center frequency is modulated in a phase modulator, which imposes a 2.488 billion bits per second (Gbps) digital signal onto the center frequency through phase shift keying. The signal is amplified and filtered to restrict the resultant signal to be within the 71-76 GHz (or 81-86 GHz) allowed pass band. A diplexer in the first transceiver is designed to transmit signals in the 71-76 GHz band and receive signals in the 81-86 GHz band. At the other transceiver, the diplexer is designed to transmit signals in the 81-86 GHz band and receive signals in the 71-76 GHz band. After reception, the signal passes through a band pass filter (to discriminate against transmitted signals), a low noise amplifier and another band pass filter. The received signal is then mixed down to a lower frequency centered at 9.8 GHz (which is the difference between the transmitted and received frequency) and combined with a steady 9.8 GHz reference signal in order to demodulate the original data. The steady 9.8 GHz reference signal is kept in phase with the received data through the use of a phase locked loop. To eliminate ambiguity that would normally occur with regard to which phase corresponds to a digital zero and which phase corresponds to a digital one, the original data is encoded such that a transition in phase corresponds to a digital one, and no transition in phase (at the time when a transition could occur) corresponds to a digital zero.

In a specific preferred embodiment, the modulated output of each transmitter is fed to a quasi-optical grid high-power amplifier that increases the transmitted power from approximately 100 mW to approximately 1 W or more.

Preferred embodiments include automatic transmit power control electronics that provide for continuous communication between transceivers of each transceiver's received power level. A digital processor in each transceiver monitors received signal strength. The received power level is communicated from one transceiver to the other using a separate (from the main data channel) communications channel. In preferred embodiments this separate communications channel is implemented by imposing a relatively slow amplitude modulation onto the transmitted signal, of only a few percent of the total transmitted power. This relatively low frequency modulation is used to form a continuous serial link between digital processors at each transceiver at 56 thousand bits per second, and is separate from the high-speed data that is transmitted over the link, which operates at 2.488 billion bits per second. Automatic gain control circuitry is used to sense this low-frequency modulation of the amplitude of the received signal to detect transmit power information imposed on the main signal at the other transceiver. In these preferred embodiments amplifiers, that are used to adjust the total transmitted power level for transmit power control, are also used to transmit digital information regarding received signal amplitude.

The data can be modulated onto the millimeter wave center frequency by a number of methods including on-off keying, simple amplitude modulation, higher order amplitude modulation, frequency modulation, phase modulation, or some combination of these. In one preferred embodiment of the present invention the data is modulated onto the carrier using dual phase shift keying (DPSK) whereby the phase of the carrier is varied between two settings that are 180 degrees out of phase. In another preferred embodiment, higher data rates, such as 10 Gbps, could be transmitted in the available bandwidth by using higher order phase modulation such as quaternary phase shift keying (QPSK) where the phase of the carrier varies between four settings that are 90 degrees apart.

Transceivers forming each end of the link may be mounted on the outside of and near the top of a building. The mounts holding the transceivers and the attachment locations on the building are typically chosen so as to minimize movement with changing weather conditions so that the transceivers will maintain pointing to each other within a fraction of their beam widths, which are typically less than a degree. Active tracking may also be provided. In alternate preferred embodiments, the transceivers could be mounted inside a building behind windows, on permanent towers, or on temporary towers erected for providing high bandwidth communications for a short period of time. For example, in one preferred embodiment the invention could be used to restore long haul telecommunications traffic between sections of a fiber that have been severed by a natural disaster, such as a bridge across a river collapsing during a flood. For example, four different wavelengths propagating through an optical fiber and carrying four separate date streams at 2.5 Gbps each could be separated out and sent to four transceivers mounted on temporary towers on one side of the river. The four data channels could then be sent across the river to opposite transceivers using the E-band millimeter wave communications. After reception on the other side of the river, the four different fiber wavelengths could be regenerated with the four data channels, and combined into the optical fiber continuing on that side of the river.

In accordance with the present invention, it is desirable to maintain high link availability (or uptime) at a maximum link range in varying weather conditions. The primary weather condition that affects link range for the E-band millimeter wave communications system is heavy rain. Within the United States, rain rate distributions have been partitioned into several different regions called Crane regions. Of primary commercial concern is the Crane region that includes the largest cities on the eastern seaboard such as Washington, New York and Boston, along with Chicago in the Midwest. In this Crane region, the preferred embodiment has a weather availability of 99.999% at a distance of 0.68 miles, which is far higher than any other wireless technology can provide at this distance at a 2.488 Gbps data rate. In other, drier regions, the operating distance at 99.999% availability is even further. Similarly, at lower availabilities such as 99.99% or 99.9%, the preferred embodiment will operate at significantly longer distances in all Crane regions.

A preferred antenna is a two-foot diameter parabolic dish antenna with a feed through the primary mirror and a small secondary mirror, and an electronics box mounted to the antenna. The circuitry that transmits and receives the modulated millimeter wave signals is contained within the electronics box. The transceiver connects to a user in the building on which it is mounted through a fiber optic cable, containing separate fibers for sending and receiving data. In addition, there is a power connection to provide power (for instance 110 V A.C.) to the transceiver. Within the electronics box there is both digital data forming and diagnostic circuitry, and microwave and millimeter wave circuitry.

### BRIEF DESCRIPTION OF THE DRAWINGS

FIG. 1 is a diagrammatic view of two E-band millimeter wave communications transceivers of the present invention mounted on buildings and positioned relative to each other to establish a line-of-sight communications link.

FIG. 2 is a diagrammatic view of an application of the present invention to restore telecommunications after a bridge collapse, showing operation of multiple E-band transceivers in close proximity without interference.

FIG. 3 is a map of the United States showing the range at which a system of the present invention could be expected to operate with 99.999% availability.

FIG. 4 is a cross-sectional drawing of a millimeter wave communications transceiver of the present invention.

FIG. 5 is a block diagram showing components used to build the millimeter wave communications system of the present invention.

FIGS. 5A and 5B are block diagrams showing features of two transceivers forming a communication link.

FIGS. 6A through 61 are a series of theoretical waveforms used to show the electric field versus time and the frequency spectrum of the signal at various points in the block diagram.

FIG. 7 is a block diagram showing operation of the automatic transmit power control which is an aspect of the present invention.

FIGS. 8A and 8B are block diagrams showing features of a Non-Return to Zero, Inverted (NRZI) encoder circuit, and a NRZI decoder circuit.

FIG. 9 is a diagram of a typical quasi-optical grid power amplifier.

FIG. 10 is a drawing of a prior art grid amplifier.

### DETAILED DESCRIPTION OF PREFERRED EMBODIMENTS

### First Preferred Embodiment

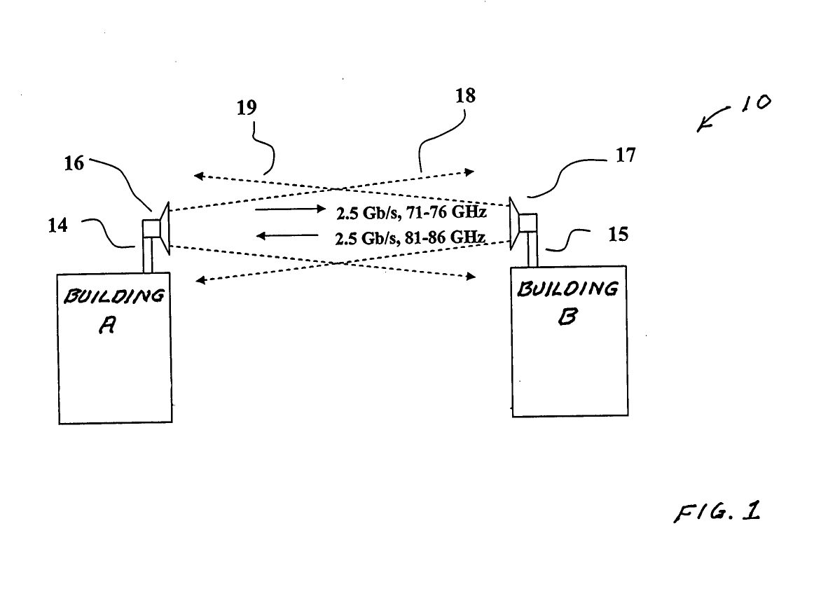

Referring initially to FIG. 1, a millimeter wave communications link in accordance with the present invention is shown and generally designated 10. As shown, the link 10 includes two transceivers 16 and 17, which can be positioned to have a line-of-sight relationship with each other for the purpose of establishing a communications link. The transceivers 16 and 17 have substantially the same structure, except that transceiver 16 transmits millimeter waves 18 in a frequency band between 71 and 76 GHz, and transceiver 17 transmits millimeter waves 19 in a frequency band between 81 and 86 GHz.

As shown in FIG. 1 transceiver 16 is mounted on stiff mount 14, which is attached to the roof of building A, while transceiver 17 is mounted on stiff mount 15, which is attached to the roof of building B, located about 0.5 miles distant from building A. For the preferred embodiment the transceivers have antennas with 2-foot diameters, leading to half power beam widths of approximately one-half a degree. Therefore, to avoid the necessity of active tracking, it is optimal to have the stiff mounts designed and attached to the building in such a way as to keep any angular movement less than a fraction of the half degree beam width. For instance, mounting the antennas at the corner of a building will generally achieve this desired result.

### Structural Elements

FIG. 4 shows a cross-sectional view of an E-band millimeter wave transceiver of the present invention. This figure basically shows the mechanical structure of a preferred embodiment. In receive mode, millimeter waves entering parabolic reflective antenna 40 (manufactured by Milliflect Corporation, Newark, Calif., and others) from the left within the receive angle of the antenna will be focused towards hyperbolic reflector 41 and then will be reflected into waveguide horn 42. In transmit mode (which occurs simultaneously with receive mode), millimeter waves emanate from waveguide horn 42 to reflect off of reflector 41, and expand to fill parabolic reflective antenna 40 before being transmitted to the left in a millimeter wave beam that is typically as nearly collimated as allowed by the laws of diffraction. Such parabolic antenna assemblies are well known in the art. In addition, to achieve high sidelobe suppression to minimize interference with other links, the output intensity over the diameter of the parabolic antenna should be tapered from a peak on center down to a low level at the edges of the antenna.

Continuing in FIG. 4, the parabolic dish antenna and millimeter wave waveguide horn are mechanically attached to a housing 48 that is used to hold the digital and analog electronics associated with the millimeter wave transceiver. There is an antenna mount bracket at 44. The millimeter wave and microwave electronics 46 are mounted near the waveguide horn at the back of antenna 40 within housing 48. A main housing is designated 48, with access through rear housing cover 50. The controller printed circuit board assembly, containing digital interface electronics, is mounted inside the housing at 52. Other subsystems include the power supply 56 (manufactured by Condor Corporation, Oxnard, Calif., and others), a cable connector 54 and concealed handle assembly 58. For the purposes of this invention, there is nothing particularly important about this exact arrangement of subsystems. However, it is to be appreciated that the transceiver has been designed in a modular fashion for ease of making changes to various components.

### Electronics

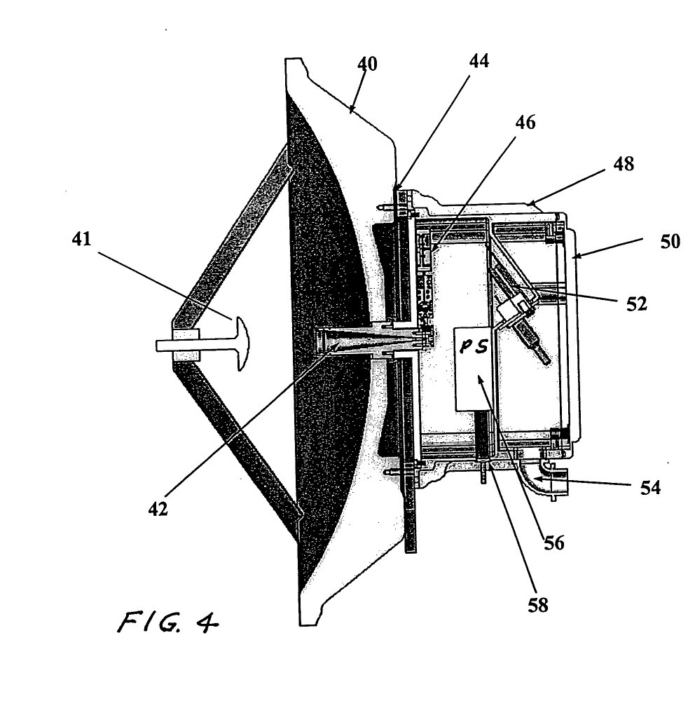

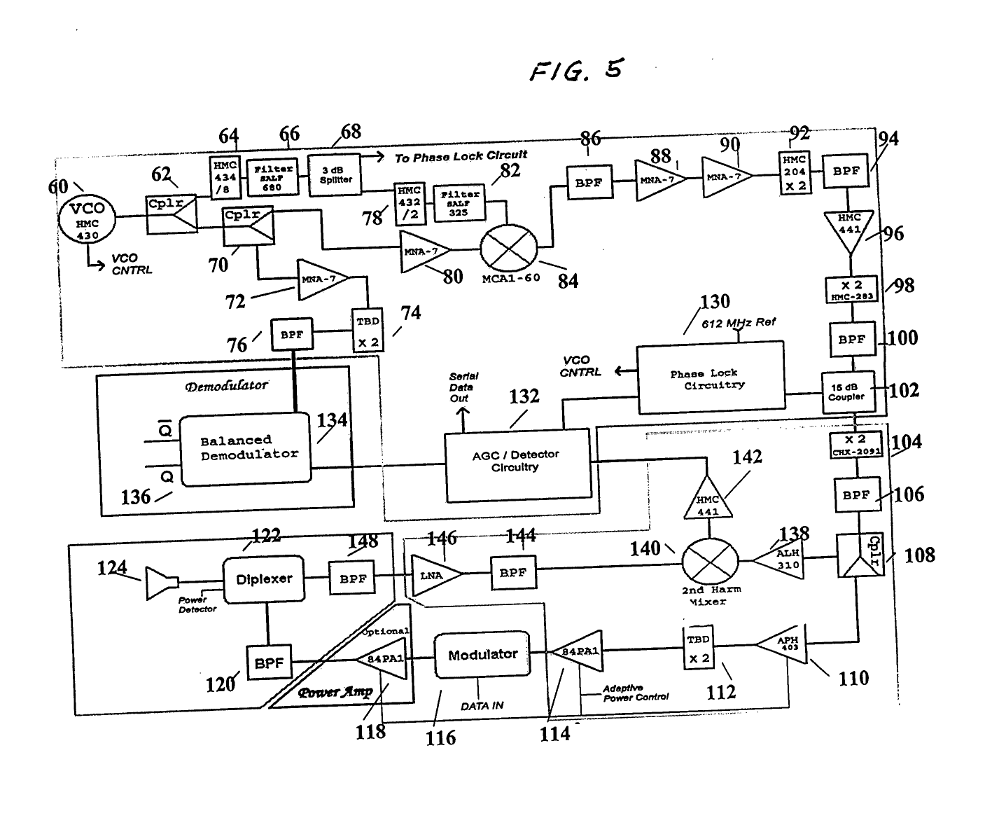

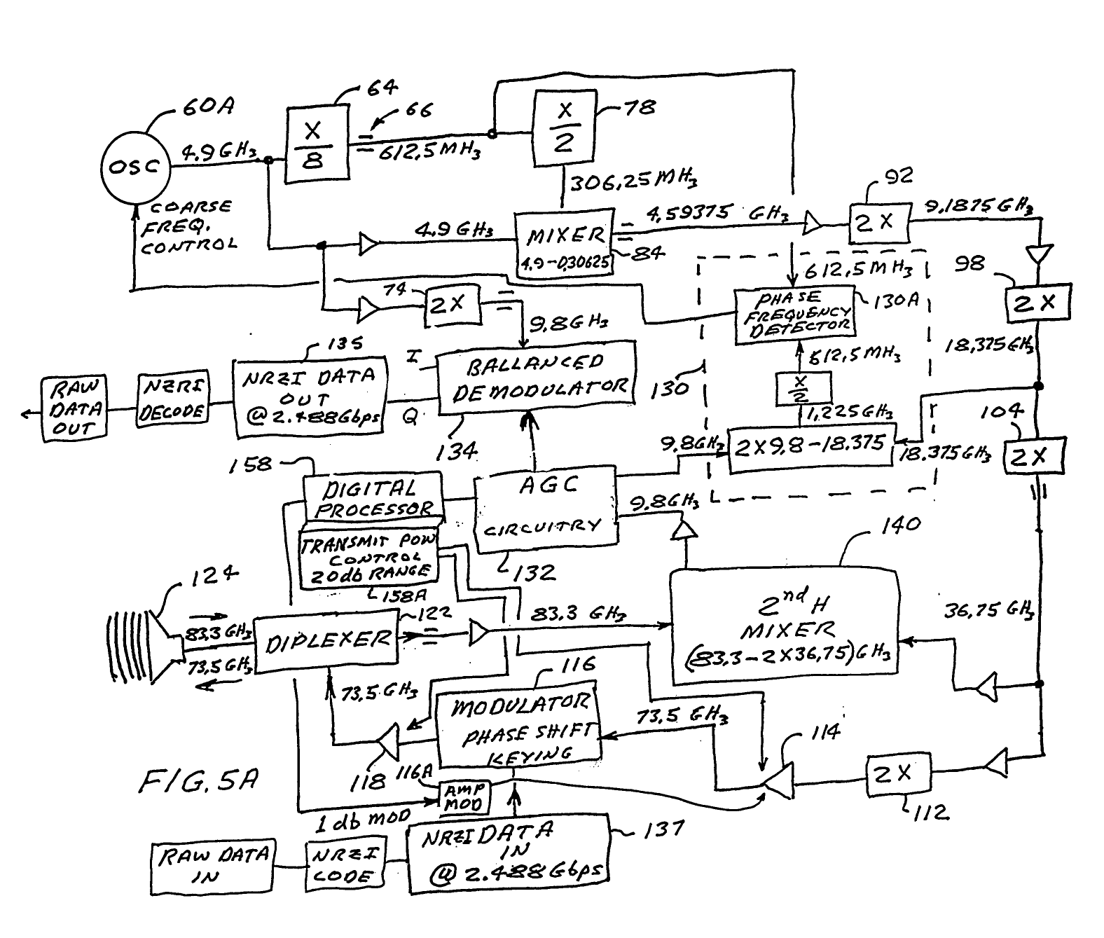

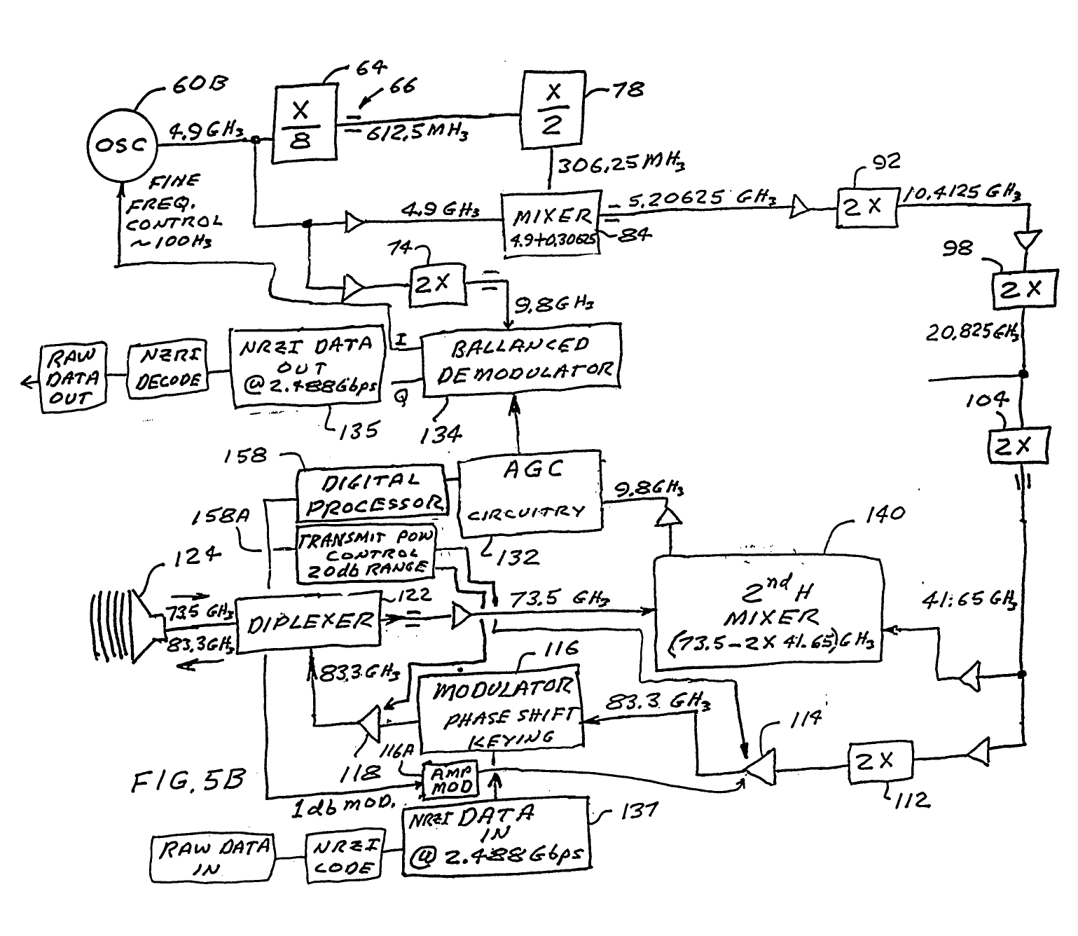

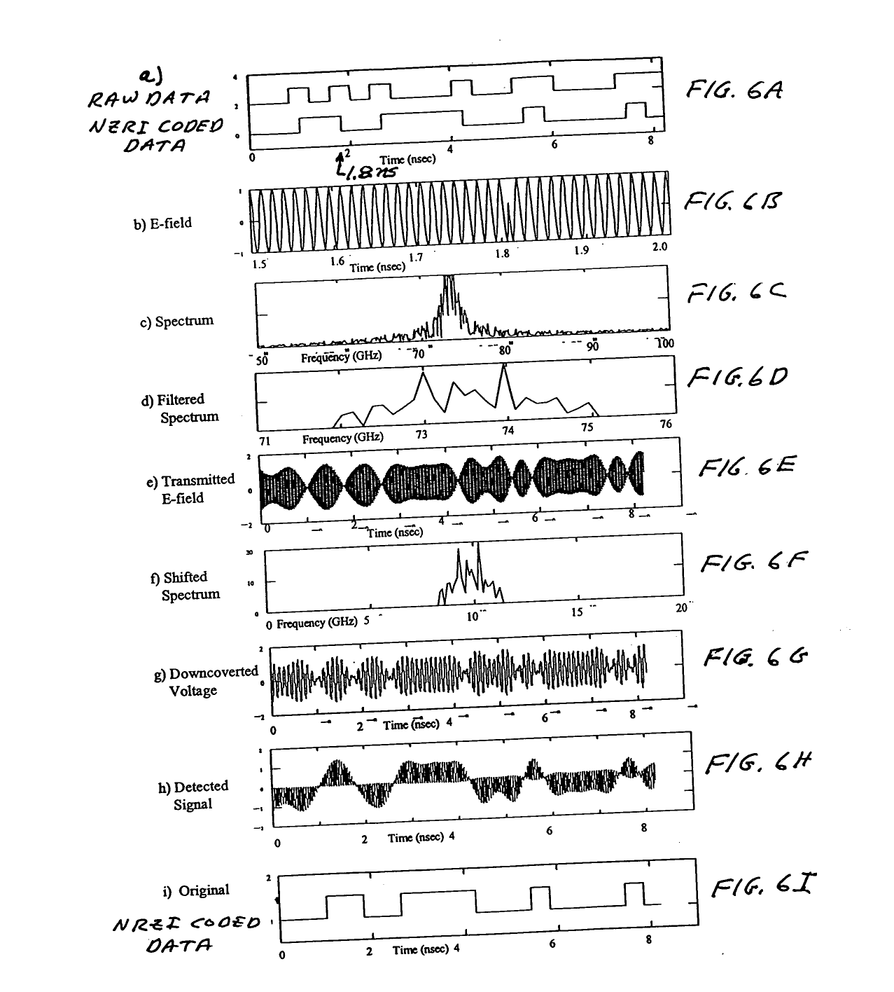

FIG. 5 is a block diagram of microwave and millimeter wave electronics contained in the E-band millimeter wave communications transceiver, and showing many of the features that are unique to the present invention. In discussing the components designated in FIG. 5, reference will also be made to the waveforms shown in FIG. 6, which highlight what is happening at certain critical stages as the communications signal moves through the transceiver electronics. Reference will also be made to FIGS. 5A and 5B, which describe more specifically the generation of signal frequencies of the two transceivers. The significant differences between the two transceivers are the result of oscillator 60A in the transceiver transmitting at 71-76 GHz (FIG. 5A) being designated as the slave oscillator and oscillator 60B in the transceiver transmitting at 81-86 GHz (FIG. 5B) being designated as the master oscillator. FIGS. 5A and 5B show the same information as FIG. 5 but with more emphasis on techniques used to produce frequencies. FIG. 5A describes the transceiver transmitting at 73.5 GHz and receiving at 83.3 GHz and FIG. 5B describes the transceiver transmitting at 83.3 GHz and receiving at 73.5 GHz. The frequencies of the signals beginning with oscillators 60A and 60B are shown above the lines connecting the identified components. The 73.5 GHz center frequency is produced by subtracting from the first transceiver's basic frequency signal of 4.9 GHz its frequency divided by eight (4.9 GHz/8=0.6125 GHz) and by two (0.6125 GHz/2=0.30625 GHz) or (4.9 GHz−0.30625 GHz=4.59375 GHz) and doubling the resulting frequency four times (4.59375 GHz×2 4=73.5 GHz). The 83.3 GHz center frequency is produced by adding to the second transceiver's basic frequency of 4.9 GHz its frequency divided by eight and two (4.9 GHz+0.6125 GHz/2=5.20626 GHz) and doubling the resulting frequency four times (5.20626 GHz×2⁴=83.3 GHz).

Our description of FIG. 5 starts at Voltage Controlled Oscillator 60 (part #HMC430 manufactured by Hittite Microwave Corporation, Chelmsford, Mass.), which generates a varying electrical voltage in a sine wave pattern at a frequency of 4.9 GHz. This unit is a Ga As InGaP heterojunction bipolar transistor MMIC voltage controlled oscillator. The output frequency varies from about 4.62 GHz at zero Volts to about 5.62 GHz at about 10 tuning Volts. This 4.9 GHz base frequency is used to generate a transmit center frequency of either 73.5 GHz or 83.3 GHz (depending on whether the particular transceiver is transmitting in the 71-76 GHz band or the 81-86 GHz band). As will be seen, the same 4.9 GHz output frequency of the Voltage Controlled Oscillator is also used to generate a stable local oscillator signal to compare with the signal received by the transceiver. For the discussion that follows, we will assume that this particular transceiver is transmitting in the 71-76 GHz band and receiving in the 81-86 GHz band. The circuit diagram is substantially the same for a transceiver transmitting in the 81-86 GHz band and receiving in the 71-76 GHz band, with some alterations made in the oscillator controls and the passband of the Band Pass Filters. FIG. 5 is representative of both transceivers. FIG. 5A represents the transceiver that transmits at 71-76 GHz and

FIG. 5B represents the transceiver that transmits at 81-86 GHz. After leaving the Voltage Controlled Oscillator 60, the 4.9 GHz signal enters coupler 62, which splits the voltage onto two paths. On the upper path, the 4.9 GHz signal enters divider 64 (part #HMC434 manufactured by Hittite Microwave Corporation, Chelmsford, Mass.), which divides the frequency by 8 down to 612.5 MHz. This signal passes through filter 66 (part #SALF680 manufactured by Mini-Circuits Corporation, Brooklyn, N.Y.), and then into 3 dB splitter 68, where half of the output is used later in phase locking circuitry 130 (key component is phase detector part #HMC439QS16G manufactured by Hittite Microwave Corporation, Chelmsford, Mass.), and half continues on to frequency divider 78 (part #HMC432 manufactured by Hittite Microwave Corporation, Chelmsford, Mass.), which divides the frequency by 2 down to 306.25 MHz. Now looking at the lower path leaving coupler 62, the 4.9 GHz voltage signal enters coupler 70, where some of the voltage is split off to amplifier 72 (part #MNA-7 manufactured by Mini-Circuits Corporation, Brooklyn, N.Y.), and some is split off to amplifier 80 (part #MNA-7 manufactured by Mini-Circuits Corporation, Brooklyn, N.Y.). For now we continue with the signal from amplifier 80, which next enters mixer 84 (part #HMC488MS8G manufactured by Hittite Microwave Corporation, Chelmsford, Mass.), where it is mixed with the 306.25 MHz signal from the upper path. The output from mixer 84 is at a frequency of 4.9 GHz−306.25 MHz, or 4.59375 GHz. (The other output frequency of 4.9 GHz+306.25 MHz=5.20625 GHz would be used for an 81-86 GHz transmitting system). The 4.59375 GHz signal now passes through bandpass filter 86 and amplifier 88 (part #MNA-7 manufactured by Mini-Circuits Corporation, Brooklyn, N.Y.) and amplifier 90 (part #MNA-7 manufactured by Mini-Circuits Corporation, Brooklyn, N.Y.) before entering frequency doubler 92 (part #HMC368LP4 manufactured by Hittite Microwave Corporation, Chelmsford, Mass.), which generates an output frequency of 9.1875 GHz. This 9.1875 GHz frequency signal is filtered by filter 94 and amplified by amplifier 96 (part #HMC411LP3 manufactured by Hittite Microwave Corporation, Chelmsford, Mass.) before entering frequency doubler 98 (part #HMC283LM1 manufactured by Hittite Microwave Corporation, Chelmsford, Mass.), which generates an output frequency of 18.375 GHz.

After passing through bandpass filter 100, this 18.375 GHz voltage sine wave passes through 15 dB Coupler 102. About 3% of the signal enters Phase Lock Circuitry 130, and the other 97% enters frequency doubler 104 (part #HMC283LM1 manufactured by Hittite Microwave Corporation, Chelmsford, Mass.), which generates a frequency of 36.75 GHz at the output. This 36.75 GHz output signal then passes through bandpass filter 106 and enters coupler 108, which separates off some of the signal to be amplified by amplifier 138 (part #HMC283LM1, manufactured by Hittite Microwave Corporation, Chelmsford, Mass.) and used by the receiver circuitry starting at second harmonic mixer 140 (manufactured by Hittite Microwave Corporation, Chelmsford, Mass.). Saving that for later, we continue on from coupler 108 to amplifier 110 (manufactured by Hittite Microwave Corporation, Chelmsford, Mass.), whose 36.75 GHz output enters frequency doubler 112 (manufactured by Hittite Microwave Corporation, Chelmsford, Mass.) to generate a carrier frequency at 73.5 GHz. (If the circuit was for a transmitter in the 81-86 GHz band, the steps above would have led to frequencies of 10.4125 GHz at doubler 92, 20.825 GHz at doubler 98, 41.65 GHz at doubler 104, and 83.3 GHz at doubler 112, all as shown in FIG. 5B).

### Transmit Power Control

After the 73.5 GHz carrier frequency is generated by frequency doubler 112, it is amplified by amplifier 114 (made by Northrop Grumman Corporation) up to a power level of 100 mW. The power out of this amplifier 114 and amplifier 118 can be varied for the purposes of changing the transceiver transmit power depending on weather conditions as is discussed in more detail below.

### Modulation

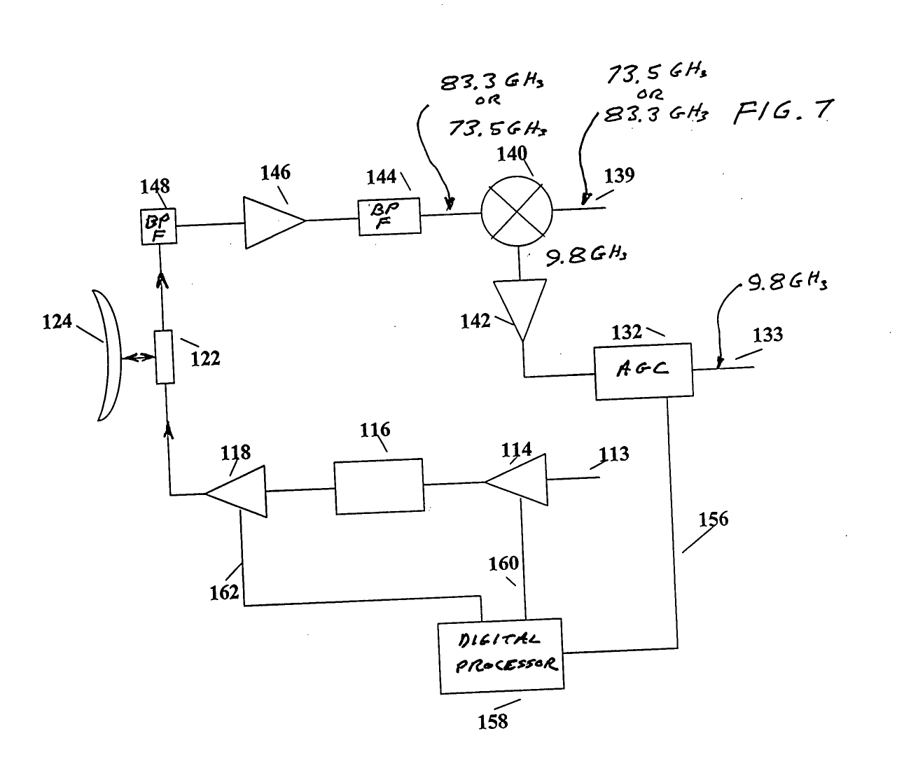

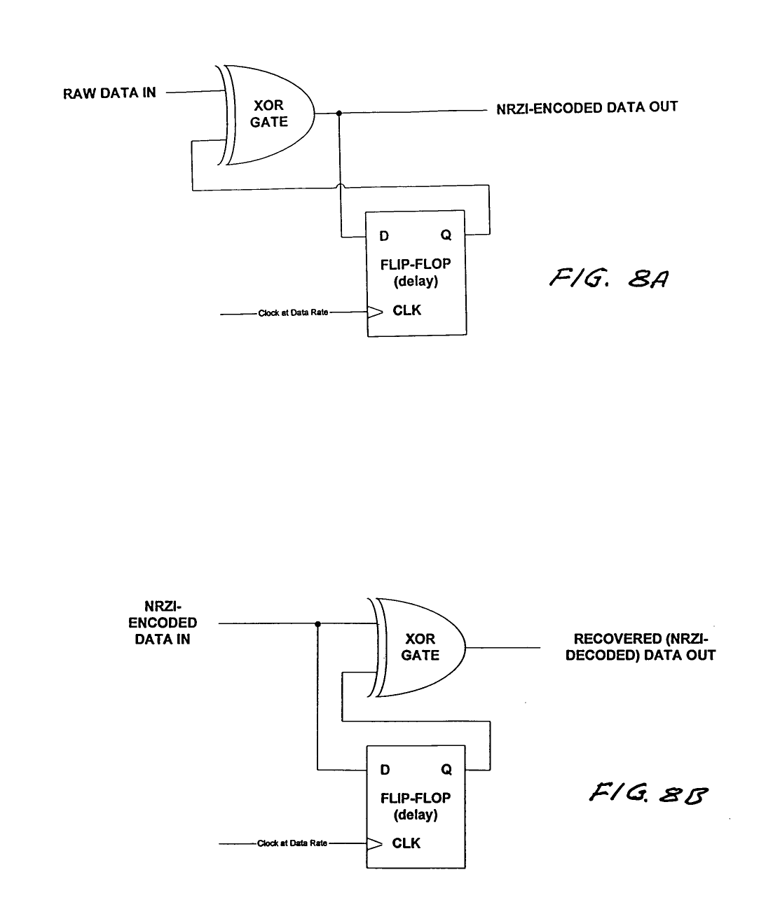

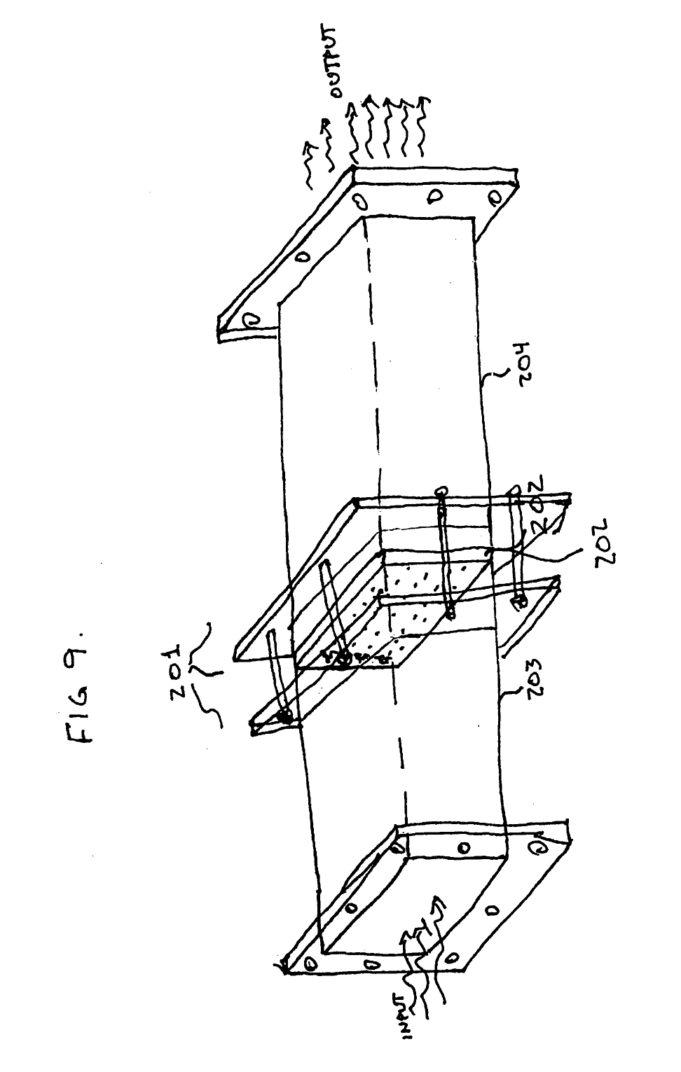

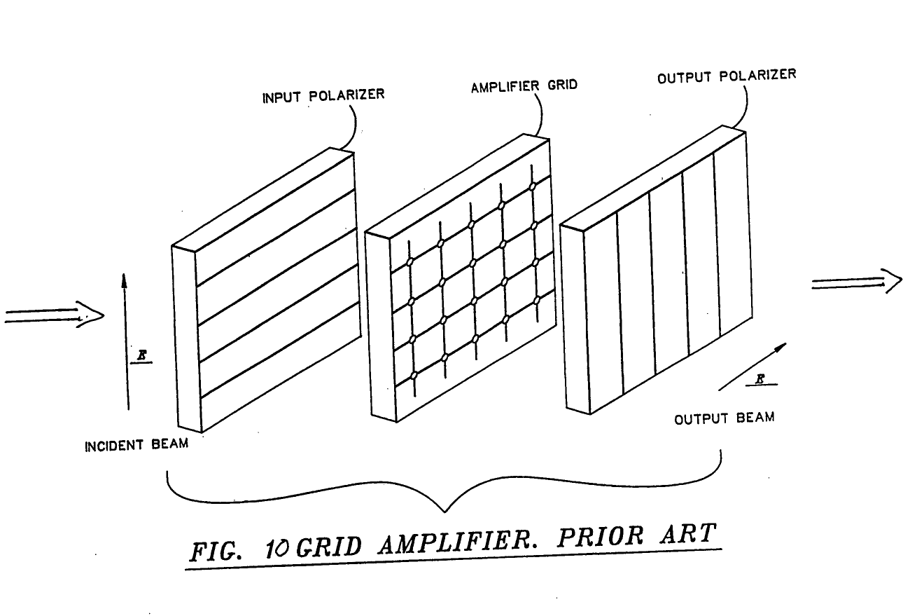

After leaving amplifier 114, the 73.5 GHz carrier is modulated by Modulator 116 to impose a phase shift keyed data signal on it at a data rate of 2.488 Gbps. The nature of this modulation can be understood by reference to FIG. 6. The top part of FIG. 6A shows a data stream at a data rate of 2.5 Gbps consisting of “1”s and “0”s generated from an external data source and converted to an electrical signal. To remove later ambiguity about which phase of the phase shifted signal corresponds to a “1” or “0”, the raw data stream is Non-Return to Zero Inverted (NRZI) encoded by NRZI Encoder 149 as shown in the bottom part of FIG. 6A. (NRZI encoding is used to make the serial bit stream insensitive to polarity, and to overcome clock recovery difficulties that could be caused by long streams of 1's in the original data. NRZI encoding is commonly used in the industry in a wide variety of devices that employ serial data links, including the Universal Serial Bus (USB) standard, and the Serial Data Interface (SDI) standard for digital television. A search of the World Wide Web using the terms “NRZI” and “encode” will turn up many sources explaining NRZI encoding.) NRZI encoder 149 implements logic illustrated in FIG. 8A. De-coding is performed in a similar fashion by NRZI decoder 150, which implements logic as shown in FIG. 8B. By performing NRZI encoding to the raw data signal before transmission, the received signal, after decoding, is insensitive to polarity. If an inversion of the data stream should occur, due to a phase ambiguity, the NRZI decoding process will continue to recover the raw data as if no such inversion had occurred. If should also be noted that in addition to NRZI encoding, privacy or encryption coding/decoding could be performed as well. For example, the delay time that determines the raw data bits which undergo the XOR function in the encoder can be varied from one bit time to a user settable number of bit times, and the decoder would have to be matched to the encoder.

In FIG. 6B we see the voltage or electric field of the 73.5 GHz carrier with a phase transition just after the 1.8 nanosecond time mark. This highlights what the modulator does to the carrier to impose a 180-degree phase shift every time there is a transition in the NRZI data. Before being modulated, the frequency spectrum of the carrier would be a very sharp spike at the 73.5 GHz frequency, with no power at other frequencies. With a perfect modulation, the frequency spectrum is shown in FIG. 6C assuming the data stream from FIG. 6A. As can be seen, the frequency spectrum now spans a large frequency range. This frequency range is larger than what FCC rules would allow to be transmitted, and must therefore be truncated to fall within the available transmit bandwidth. This truncation is done with bandpass filter 120 (FIG. 5) after the signal passes through operational amplifier 118, which can boost the power to the order of 100 mW or more. Filtering the spectrum with a 3 GHz wide bandpass filter extending from 72 to 75 GHz results in the filtered power spectrum shown in FIG. 6D. The modulated signal filtered to this frequency band passes from Bandpass filter 120 into Diplexer 122 (FIG. 5) and is directed to antenna 124 for broadcast into free space. The Diplexer 122 is designed to separate out the transmitted signal centered at 73.5 GHz from the received signal centered at 83.3 GHz. These types of diplexers are available from suppliers such as Sisson Engineering, Northfield, Mass. The signal that is transmitted through space from one transceiver to the other has the amplitude shown in FIG. 6E. Because of the truncation of the spectrum, there is quite a bit of amplitude modulation as compared to FIG. 6B where there was only phase modulation. Still, the locations of phase transition can be clearly seen in the signal of FIG. 6E as they correspond to locations where the amplitude becomes small.

### Grid Amplifier

After being modulated by modulator 116, as described above and amplified by amplifier 118 for purposes of transmit power control as described in a following section, the signal is passed to quasi-optical grid amplifier 201 (made by Wavestream Corp., San Dimas, Calif.), which amplifies the signal power to approximately 1 watt. The amplified signal then passes to diplexer 122 and then to antenna 40.

FIG. 9 illustrates a quasi-optical grid amplifier 201 of the type manufactured by Wavestream Corporation. Integrated circuit 202 contains an array of transistor amplifiers spaced approximately 1/10 wavelength apart across the surface of Integrated Circuit 202. A low power millimeter-wave input signal proceeds along Input Waveguide Cavity 203 and impinges upon the upstream surface of Integrated Circuit 202. Each individual transistor amplifier on Integrated Circuit 202 amplifies a small portion of the low power input signal and passes the amplified portion to the downstream surface of Integrated Circuit 202. The amplified signal portions combine at the downstream surface of Integrated Circuit 202 to form a high power output signal, which proceeds along Output Waveguide Cavity 204.

### Receive Signal

Let us now move on to the receiving part of the transceiver in FIG. 5. Since we are considering a single transceiver 16 as shown in FIG. 1 that transmits at 73.5 GHz, we will assume we are receiving a signal centered at 83.3 GHz broadcast by transceiver 17. For the purposes of this discussion, we will assume that the same data as was shown in FIG. 6 is being received. The 83.3 GHz signal being received is collected by antenna 124 and directed into frequency diplexer 122. This diplexer passes the majority of the received signal centered at 83.3 GHz on to bandpass filter 148, while directing a minimum of transmitted signal at 73.5 GHz in that direction. Bandpass filter 148 serves to further reduce any unwanted interference from the transmitter. The received signal is at a very low level, typically on the order of 100 nW, and is amplified by Low Noise Amplifier 146 (manufactured by Raytheon Corporation, Andover, Mass.) before passing through another bandpass filter 144. After this amplification and filtering at the 83.3 GHz center frequency, the high frequency is mixed down to a lower frequency for detection.

As was mentioned previously, some of the power at a frequency of 36.75 GHz from the transmit carrier chain was split off by Coupler 108 and amplified by Amplifier 138. Both this 36.75 GHz reference signal and the amplified received signal at 83.3 GHz enter Second Harmonic Mixer 140 (manufactured by Hittite Microwave Corporation, Chelmsford, Mass.). The output of the Second Harmonic Mixer is centered at a frequency of 9.8 GHz, corresponding to 83.3 GHz minus 2×36.75 GHz. This output signal also contains the received data and is amplified by Amplifier 142 (manufactured by Hittite Microwave Corporation, Chelmsford, Mass.). The spectrum of the received signal after it has been down-converted in frequency can be seen in FIG. 6F. The voltage (or electric field) as a function of time corresponding to this down-converted signal is shown in FIG. 6G, where the phase transitions can be seen. At the 9.8 GHz carrier frequency there are only about 4 voltage oscillations in a bit period as compared to 83.3 GHz where there are about 33.

After the down-converted signal at 9.8 GHz is amplified by Amplifier 142, it enters automatic gain control circuitry 132 (key components are part #'s HMC346LP3 and HMC441LP3, manufactured by Hittite Microwave Corporation, Chelmsford, Mass.). For the high data rate receive signal, this circuitry serves the purpose of signal voltage control, to set the data signal to a set voltage range, independent of the received signal strength at the antenna. (This circuitry also monitors the incoming signal and if it is too low or too high, the circuitry provides information for transmittal to transceiver 17, all as discussed in a section below entitled “Automatic Transmit Power Control”.)

### Demodulation

After this signal voltage control step, the data signal enters Balanced Demodulator 134 (manufactured by Hittite Microwave Corporation, Chelmsford, Mass.), which extracts the NRZI-encoded data that was modulated onto the carrier by the transmitter at the other end of the link. It extracts this data by mixing the data signal with a reference signal that is kept in phase with the data signal. The reference signal is generated as part of the frequency multiplication chain of the transmitter, and originates from the same Voltage Controlled Oscillator 60. Part of this 4.9 GHz signal passes through Coupler 62 to Coupler 70, from which it passes to Amplifier 72. The frequency of this amplified signal at 4.9 GHz is then doubled to 9.8 GHz by Frequency Doubler 74 (part #HMC283 manufactured by Hittite Microwave Corporation, Chelmsford, Mass.). This 9.8 GHz reference signal is filtered by Band Pass Filter 76, and then enters Balanced Demodulator 134 for mixing with the down-converted received data signal. For this demodulation to work, it is critical that the reference signal at 9.8 GHz maintain a constant phase relationship with the down-converted receive data signal at 9.8 GHz. The result of mixing of the reference and data signals is shown in FIG. 6H as the Detected Signal. Where the reference and data signals are in phase, the voltages are positive. Where the reference and data signals are out of phase, the voltages are negative. The original NRZI-encoded data is then extracted (as the Q signal as shown exiting demodulator 134) by comparing the Detected Signal voltages to a zero voltage reference, as shown in FIG. 61.

### Phase Lock and Mode Lock

As mentioned previously, it is critical that the reference signal maintain a constant phase relationship with the down-converted receive data signal. This phase locking function is accomplished by Phase Lock Circuitry 130 (FIG. 5 and FIG. 5A). Phase Lock Circuitry 130 relies on three inputs for its operation. One of these inputs is a 612.5 MHz reference signal output by 3 dB Splitter 68. A second input is a signal at a frequency of 18.375 GHz, which is split off from 15 dB Coupler 102. The third input is the 9.8 GHz carrier (and data) from AGC Circuitry 132. Within the Phase Lock Circuitry 130, the 9.8 GHz carrier is doubled and amplified resulting in a frequency of 19.6 GHz. This is mixed with the 18.375 GHz signal from Coupler 102 resulting in a frequency of 1.225 GHz. The frequency of this 1.225 GHz signal is divided by 2 using a frequency divider, resulting in a signal at 612.5 MHz. This 612.5 MHz signal is compared with the 612.5 MHz reference signal from Coupler 68 in a Phase Frequency Detector 130A (part #HMC439QS16G manufactured by Hittite Microwave Corporation, Chelmsford, Mass.). The step of doubling the signal to 19.6 GHz is necessary to regenerate a central carrier frequency, which is missing in the 9.8 GHz spectrum.

The output of the Phase Frequency Detector is sent to Voltage Controlled Oscillator 60, closing a feedback loop, which attempts to vary the frequency of VCO 60 so that no phase shift is detected relative to the incoming data signal in the Phase Frequency Detector. This phase locking has to work simultaneously in the transceivers at both ends of the link. For this purpose, oscillator 60B in one of the transceivers (in this case transceiver 17 transmitting at 81-86 GHz shown in FIG. 5B) is designated as a master oscillator and the other (60A in transceiver 17, FIG. 5A) as a slave, so that the overall frequency is controlled from one end of the link. Therefore the transceiver depicted in FIG. 5B does not contain phase lock circuitry 130 as shown in FIG. 5A, or if it does it is not activated.

Since we are dealing with wavelengths of only about 3 mm and expect the transceiver will be mounted on buildings or towers that will move more than 3 mm with wind and temperature changes, preferred embodiments are designed to modify the frequency of the master oscillator (60B in transceiver 17, FIG. 5B) to maintain the number of wavelengths in the beam between the two transceivers at a constant number. Applicants refer to this feature as “mode locking”. This is accomplished using the I signal produced by the balanced demodulator circuit 134. When the two 9.8 Ghz signals entering balanced demodulator 134 shown in FIG. 5B are in phase the I signal is equal to zero voltage. As the phases drift apart this I signal will vary in voltage plus or minus from zero. That plus or minus voltage is fed into an operational amplifier (not shown) that adjusts a fine frequency control of master oscillator 60B in to keep the “I” signal at approximately zero. This assures a constant number of wavelengths between the two transceivers. Yhe amount of frequency adjustment necessary in master oscillator 60B depends on the distance between the two transmitters and the relative amount of movement they might be subject to from building sway or other causes. If the relative movement is Δx at a distance x, then the necessary change in wavelength Δλ is given by Δλ/λ=λx/x. If the oscillator frequency is f, then Δf/f=−Δf/f=−Δx/x. For f=4.9 GHz, x=0.3 km and Δx=0.3 m, we have Δf=4.9 MHz. Thus, the master oscillator frequency is reduced to 4.88951 GHz. This amount of change in the master oscillator would change the transmit frequency from 83.3 GHz and 73.5 GHz to 83.267 GHz and 73.4265 GHz, respectively.

### Automatic Transmit Power Control

Automatic transmit control circuitry in each transceiver keeps the output transmit power of each transceiver adjusted so that the received signal at each transceiver is within a desired range of about 100 nWatts. To do this each transceiver must keep the other transceiver informed of the strength of the signals being received so that the transmitted power of each transceiver can be appropriately adjusted for varying atmospheric conditions. This is accomplished utilizing gain control circuitry 132, processor 158 and amplifiers 114 and 118 and amplitude modulator 116A in transceivers 16 and 17 at both ends of a link. For example the automatic gain control circuitry 132 of transceiver 16 on building A (refer to FIG. 5A) detects the strength of the 83.3 GHz signal received from transceiver 17 and transmits digital information to processor 158 indicating the strength. If the strength of the signal received by transceiver 16 is below a threshold of about 50 nWatts, processor 158 provides a signal to amplitude modulator 116A which contains information requesting an increase in the transmit power of transceiver 17. Modulator 116A produces an approximately 1 db modulation (at low data rate—less than 100 KHz) of the 73.5 GHz transmit signal of transceiver 16 by modulating the outpupt of amplifier 114 That low frequency signal imposed on the transmitted 73.5 GHz signal is detected by the automatic gain control circuitry 132 of transceiver 17 as shown in FIG. 5B, and processor 158 directs transmit power control 158A of transceiver 17 to increase the transmitted power as needed to produce a signal at transceiver 16 within the desired range of about 100 nWatts. The DC supplies of amplifiers 114 and 118 in transceiver 17 are both adjusted to provide the needed increase in power. In this preferred embodiment a transmit power control range of 20 db is available (corresponding to power control down to about 1 percent of maximum output). Similarly, when a transceiver detects received power in excess of a predetermined threshold (for example 150 nWatts), it will automatically call for a transmit power reduction at the other transceiver.

The operation of the gain control can be further understood by reference to FIG. 7 (which shows only components involved in transmit power control). The critical functionality here is that the transmit power needs to be modified based on the power received at the other end of the link, which requires handshaking between the two transceivers. This is accomplished using a relatively low data rate amplitude modulation superimposed on the high data rate data transmission. By keeping the communications channels separate, the data channel can be kept protocol-independent, and the data channel users need not worry about any modification or intercept of their data.

Referring to FIG. 7, incoming receive data is collected by antenna 124 and split off by diplexer 122 to Band Pass Filter 148, Low Noise Amplifier 146 and Band Pass Filter 144. From there it is mixed down to a frequency of 9.8 GHz in Sub-Harmonic Mixer 140 as discussed before. The 9.8 GHz signal is amplified by amplifier 142 before entering AGC/Detector circuitry 132, all as discussed previously. The signal entering AGC/Detector circuitry 132 has a strength that is reasonably proportional to the strength of the received signal at the antenna. In addition to the high speed (order of 2.5 Gbps) data signal phase modulated onto the 9.8 GHz received signal, there is a relatively low speed (<100 kHz) amplitude modulation containing information about the signal strength received at the other end of the link as transmitted in serial form by Digital Processor 158. This received amplitude modulation is converted to a low data rate serial digital data stream by AGC/Detector circuitry 132 and output on line 156. From line 156, the output enters Digital Processor 158 (part #Mod5282 manufactured by Netburner Corporation, San Diego, Calif.), wherein the value of the received signal at the other end of the link is calculated based on a designated interpretation. Digital Processor 158 uses this interpretation of the signal strength at the other end of the data link to adjust its transmitted power level.

### High Data Rates

The data rate is 2.488 Gbps (shown as 2.5 Gbps in FIG. 1) corresponding to standard optical fiber communications protocol OC-48. Using the present invention it would also be possible to transmit lower data rates such as gigabit Ethernet (1.25 Gbps) or higher data rates such as 10 Gbps.

### System Availability—Severe Weather

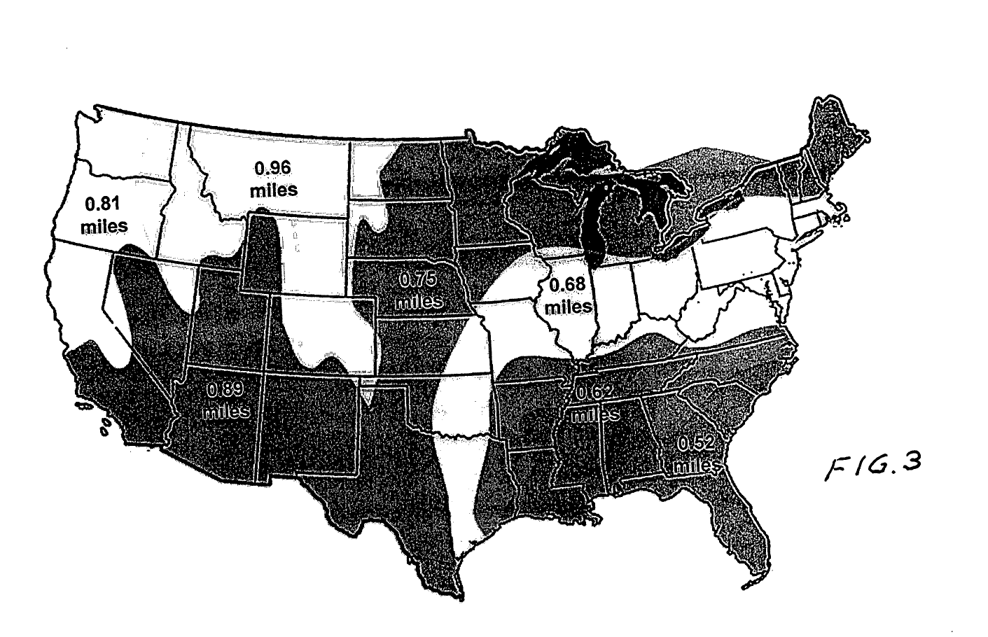

FIG. 3 shows a map of the United States divided into different Crane regions, which on some large-scale average have different distributions of rain rates over the year. These Crane regions are typically used for calculating the operational distance of radio, microwave, and millimeter wave systems. That is because the availability of such systems (the percentage of time they are operational as the weather changes) is typically affected most by heavy rain. In FIG. 3 the expected maximum distance that the E-band millimeter wave communications system of the present invention could operate is shown under the assumption that it is available 99.999% of the time, corresponding to about 5 minutes of weather related outages per year on average, which is a standard yardstick for some critical telecommunications systems. From this map, we can see that this distance is 0.68 miles over much of the most heavily populated portion of the U.S. stretching from Boston to Washington to Chicago. This distance is higher in drier climates (for instance 0.89 miles in Southern California) and also will be higher if only 99.99% or 99.9% availability is needed. Of course, it is to be understood that these distance calculations are dependent on certain fundamental operational characteristics of the E-band millimeter wave communications systems, which can be changed by design. For the example in FIG. 3, the transmit power is assumed to be 10 mW, the antenna gain is assumed to be 51 dB (corresponding to 2-foot diameter antennas), the receiver noise bandwidth is assumed to be 4 GHz, and the receiver noise figure is assumed to be 10 dB. Distances can be increased by increasing the transmitted power (to 1 W, say), by increasing the antenna diameter (to 4 feet, say) or by reducing the noise figure of the receiver. Any of these trade-offs would of course be made depending on the size of the market at different distances and how much customers are willing to pay for extra capability.

### Narrow Beam Width

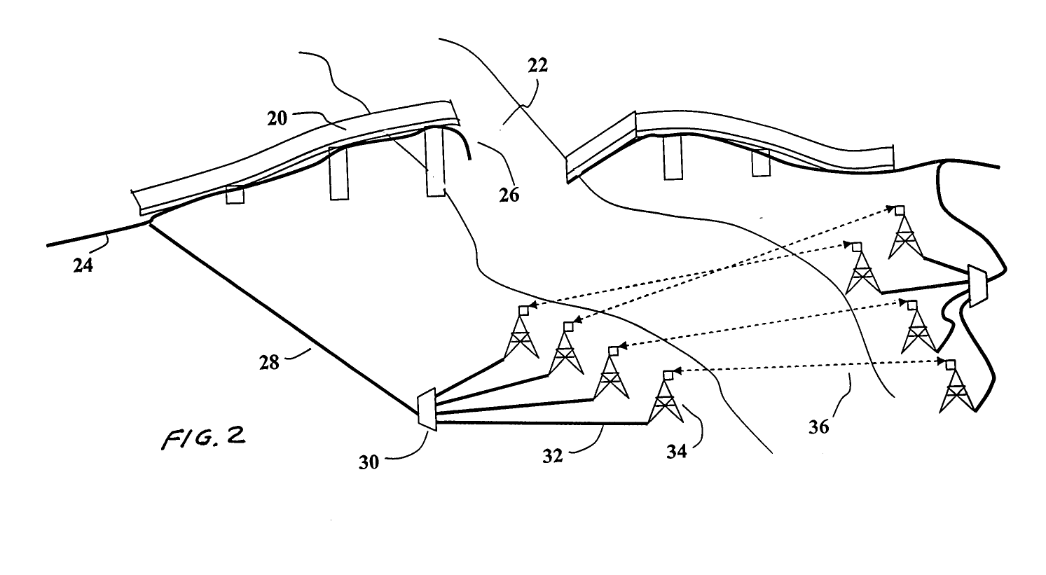

An important advantage of the present invention utilizing a two-foot (or greater) diameter antenna to keep the beam width less than 0.5 degrees is that multiple data links can be set up in close proximity to each other without causing interference between the different links. An example of how this attribute of the technology might be used in an emergency communications restoration application is shown in FIG. 2. In this application, bridge 20 has collapsed due to flooding of river 22. Prior to collapse of the bridge, data traffic was carried on 4 different wavelengths within optical fiber 24, which crossed the bridge. Each wavelength carried data at the rate of 2.5 Gbps for a total data rate of 10 Gbps. Because of the bridge collapse, fiber 24 is severed at location 26. To restore service, it may not be possible to immediately run new optical fiber across the river, or downstream to another bridge. In that case, optical fiber 28 could be spliced onto optical fiber 24 to propagate the four signals to wavelength de-multiplexer 30, which separates the 4 wavelengths onto four optical fibers (one of which is shown as fiber 32). The four fibers could then run to 4 towers on which are mounted E-band millimeter wave communications transceivers of the present invention (one of which towers is designated 34). The data could then be transmitted across the river to four reciprocal E-band transceivers mounted on towers. One such communications link is designated 36. The signals can then be regenerated in optical fibers, which are multiplexed together into a single fiber and spliced into the original optical fiber communications link. Bi-directional operation could be achieved using bi-directional, full duplex E-band millimeter wave communications links. Separate optical fibers would typically be used for the communications in each direction.

While the particular millimeter wave communications link as herein shown and disclosed in detail is fully capable of obtaining the objects and providing the advantages herein before stated, it is to be understood that it is merely illustrative of the presently preferred embodiments of the invention and that no limitations are intended to the details of constructions or design herein shown other than as described in the appended claims. For example, many other millimeter wave frequency ranges from as low as 30 GHz to over 100 GHz could be utilized using the concepts of the present invention. In addition, separate transmit and receive antennas could be used in eliminating or reducing the need for a frequency selective diplexer. In addition, the grid amplifier technology described herein can be applied at one or more millimeter wave repeater stations operating without demodulation or remodulation of the signal to extend the range of millimeter wave communication links. Modulation of the transmitted signal could be performed by direct control of the quasi-optical grid power amplifier rather than by modulation of a lower power signal prior to amplification. Although a particular millimeter wave transceiver architecture has been described here, other millimeter wave transceiver designs exist which are also amenable to use with a quasi-optical power amplifier.

What is claimed is:

1. A high data rate free space communication link operating at millimeter wave frequency ranges greater than 60 GHz, said link comprising:
A) a first transceiver configured to transmit in a first millimeter wave frequency range and comprising:
1) a first tunable oscillator, defining a master oscillator, providing a basic frequency signal;
2) electronic circuitry for generating a first center frequency utilizing the frequency signal generated by the first tunable oscillator;
3) a first modulator for modulating said first center frequency to impose a signal on said first center frequency;
4) a first demodulator,
5) a grid amplifier for amplifying transmit signals, and
6) an automatic transmit power control circuitry for assuring adequate signal transmission in a wide variety of atmospheric condition but not excessive power that might interfere with other links at the same frequencies;
B) a second transceiver configured to transmit in a second millimeter wave frequency range different from said first millimeter wave frequency range and comprising:
1) a second tunable oscillator, defining a slave oscillator, slaved to said master oscillator and oscillating with the same basic frequency as said master oscillator and in phase with said master oscillator taking into account light travel time between the first and second transceivers;
2) electronic circuitry for generating a second center frequency, different from said first center frequency, utilizing the frequency signal generated by the second tunable oscillator;
3) a second modulator for modulating said second center frequency to impose a signal on said second center frequency;
4) a second demodulator,
5) a grid amplifier for amplifying transmit signals, and
6) an automatic transmit power control circuitry for assuring adequate signal transmission in a wide variety of atmospheric conditions but not excessive power that might interfere with other links at the same frequencies.

2. The communication link as in claim 1 wherein each of said transceivers comprises an antenna for producing a beam having a beam width of about one-half degree.

3. The communication link as in claim 2 where said antenna has a diameter of about two feet or larger.

4. The communication link as in claim 1 wherein said first transceiver comprises a diplexer and is designed to transmit signals in the 71-76 GHz band and receive signals in the 81-86 GHz band and the second transceiver also comprises a diplexer and is designed to transmit signals in the 81-86 GHz band and receive signals in the 71-76 GHz band.

5. The communication link as in claim 1 wherein said master oscillator is frequency controlled to maintain a constant number of wavelengths in the millimeter wave radio beams between the two transceivers, at least for periods of time permitting substantial data transmission without change in the number of wavelengths.

6. The communication link as in claim 4 wherein both of said first and second oscillators oscillate at frequencies of about 4.9 GHz and the first transceiver has a center frequency of about 73.5 GHz and the second transceiver has a center frequency of about 83,3 GHz, wherein the 73.5 GHz center frequency is produced by subtracting from the first transceiver's basic frequency signal of 4.9 GHz its frequency divided by eight and by two and doubling the resulting frequency four times and the 83.3 GHz center frequency is produced by adding to the second transceiver's basic frequency of 4.9 GHz its frequency divided by eight and by two and doubling the resulting frequency four times.

7. The communication link as in claim 1 wherein said first modulator is programmed to impose a 2.488 Gbps digital signal onto said first center frequency through phase shift keying and said second modulator is programmed to impose a 2.488 Gbps digital signal onto said said center frequency through phase shift keying.

8. The communication link as in claim 1 wherein said first and said second modulators are programmed to modulate using a modulation method chosen from a group of methods consisting of: on-off keying, dual phase shift keying, quaternary phase shift keying, simple amplitude modulation, higher order amplitude modulation, frequency modulation, and phase modulation.

9. The communication link as in claim 7 wherein said phase shift keying utilizes NRZI encoding.

10. The communication link as in claim 1 wherein said first and said second demodulators are configured to demodulate received signals at frequencies below 15 GHz.

11. The communication link as in claim 10 wherein said first and said second demodulators are configured to demodulate received signals at frequencies of about 9.8 GHz.

12. The communication link as in claim 1 wherein said automatic transmit power control circuitry in each of said transceivers includes a digital processor programmed to monitor received signal power and to communicate to the other transceiver information about said received signal power.

13. The communication link as in claim 12 wherein said digital processor is programmed to impose a relatively slow amplitude modulation of a few percent of transmitted power onto signals transmitted at said first or second frequency ranges.

14. The communication link as in claim 13 wherein said digital processor is programmed to control at least one transmit power amplifier to impose said relatively slow amplitude modulation.

15. The communication link as in claim 1 wherein each of said transceivers also comprises automatic gain control circuitry for controlling the voltage of received data signals.

16. The communication link as in claim 1 wherein each of said first and said second tunable oscillators is a voltage controlled oscillator.

17. The communication link as in claim 1 where each of said first and said second transceivers comprise a plurality of frequency multipliers and dividers to generate respectively said first and said second center frequencies and also to generate receiver demodulation reference frequencies.

18. A high data rate free space communication link defining a first transceiver and a second transceiver, with each of said first and second transceivers operating at millimeter wave frequency ranges greater than 60 GHz, each of said transceivers comprising a grid amplifier for amplifying transmit signals at frequencies greater than 60 GHz.
